(19) United States
(12) Patent Application Publication
(10) Pub. No.: US 2026/0347233 A1
(43) Pub. Date: Nov. 5, 2026

(54) APPARATUS AND METHOD FOR SEPARATING GLASS SHEETS

(71) Applicant: CORNING INCORPORATED, CORNING, NY (US)

(72) Inventors: Chien-Ting Chen, Taichung City (TW); Yi-Cheng Hsieh, Hsinchu (TW); Sheng-Yao Kuan, Chiayi County (TW); Chia-Yang Lee, Taichung City (TW); Ching-Cheng Lin, Tainan City (TW); En-Hung Liu, Taichung City (TW); Chiu Jung Shih, Tainan City (TW)

(21) Appl. No.: 19/482,210

(22) PCT Filed: Apr. 11, 2024
(86) PCT No.: PCT/US2024/023989

§ 371 Date: Nov. 6, 2025

Related U.S. Application Data
(60) Provisional application No. 63/501,452, filed on May 11, 2023.
(60) Provisional application No. 63/606,191, filed on Dec. 5, 2023.

(51) Int. Cl. C03B 33/033; B26F 3/00

(52) U.S. Cl. CPC C03B 33/033; B26F 3/002

(57) ABSTRACT

An apparatus and method for manufacturing a glass article includes a scoring mechanism configured to impart a score line across a first major surface of the glass article and a separating mechanism that includes a glass sheet separation member with first and second raised surfaces extending along a longitudinal length of the glass sheet separation member and an intermediate surface extending therebetween, wherein the first raised surface and the second raised surface are configured to contact the glass article and the intermediate surface is configured to not contact the glass article.

### CROSS REFERENCE TO RELATED APPLICATION

This application claims the benefit of priority under 35 U.S.C. § 119 of U.S. Provisional Application Ser. No. 63/606,191 filed on Dec. 5, 2023, and the benefit of priority under 35 U.S.C. § 119 of U.S. Provisional Application Ser. No. 63/501,452 filed on May 11, 2023, the content of which is relied upon and incorporated herein by reference in their entireties.

### FIELD

The present disclosure relates generally to apparatuses and methods for separating glass sheets and more particularly apparatuses and methods for separating glass sheets with high edge quality.

### BACKGROUND

In the production of glass articles, such as glass sheets for display applications, including televisions and hand-held devices, such as telephones and tablets, large glass sheets may be produced from a glass ribbon. These large glass sheets may then be cut into smaller glass sheets or other articles. In such manufacturing, there is a continuing need to rapidly perform these operations while achieving high quality of the edge regions of the smaller glass sheets or other articles.

### SUMMARY

Embodiments disclosed herein an apparatus for manufacturing a glass article. The apparatus includes a scoring mechanism configured to impart a score line across a first major surface of the glass article. The apparatus also includes a separating mechanism that includes a glass sheet separation member. The glass sheet separation member includes a first raised surface, a second raised surface, and an intermediate surface extending between the first raised surface and the second raised surface. Each of the first raised surface, the second raised surface, and the intermediate surface extend along a longitudinal length of the glass sheet separation member. The first raised surface and the second raised surface are configured to contact the glass article and the intermediate surface is configured not to contact the glass article.

Embodiments disclosed herein also include a method for manufacturing a glass article. The method includes imparting a score line across a first major surface of the glass article with a scoring mechanism. The method also includes applying a separating force to the glass article. The separating force is applied by a glass sheet separation member. The glass sheet separation member includes a first raised surface, a second raised surface, and an intermediate surface extending between the first raised surface and the second raised surface. Each of the first raised surface, the second raised surface, and the intermediate surface extend along a longitudinal length of the glass sheet separation member. The first raised surface and the second raised surface contact the glass article and the intermediate surface does not contact the glass article.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is an perspective view of a glass sheet;

FIG. 3 is a side schematic view of a glass sheet scoring operation in accordance with embodiments disclosed herein;

FIG. 4 is an exploded side schematic view of area ‘A’ of FIG. 3;

FIG. 5 is an end cutaway schematic view of a glass sheet separation bar in accordance with embodiments disclosed herein;

FIGS. 6A and 6B are side schematic views of a glass sheet separation bar and tilting mechanism in accordance with embodiments disclosed herein;

FIGS. 7A and 7B are end schematic views of a lifting mechanism in accordance with embodiments disclosed herein;

FIG. 8 is an end cutaway schematic view of a glass sheet separation bar and support mechanism in accordance with embodiments disclosed herein;

FIGS. 9A and 9B are end cutaway schematic views of a scored glass sheet and glass sheet separation bar in accordance with embodiments disclosed herein;

FIGS. 10A and 10B are end cutaway schematic views of glass sheet separation in accordance with embodiments disclosed herein;

FIG. 11 is an end cutaway schematic view of a glass sheet separation wheel in accordance with embodiments disclosed herein;

FIG. 12 is a perspective schematic view of a glass sheet separation mechanism in accordance with embodiments disclosed herein;

FIG. 13 is an end cutaway schematic view of the glass sheet separation mechanism of FIG. 12 in a first position;

FIG. 14 is an end cutaway schematic view of the glass sheet separation mechanism of FIG. 12 in a second position;

FIG. 15 is a side cutaway schematic view of a glass sheet separation wheel cleaning mechanism in accordance with embodiments disclosed herein; and

FIG. 16 is an end cutaway schematic view of a glass sheet separation wheel cleaning mechanism in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein-for example up, down, right, left, front, back, top, bottom-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “particles” refers to any type of particles that can be present on a surface, such as glass particles and dust particles.

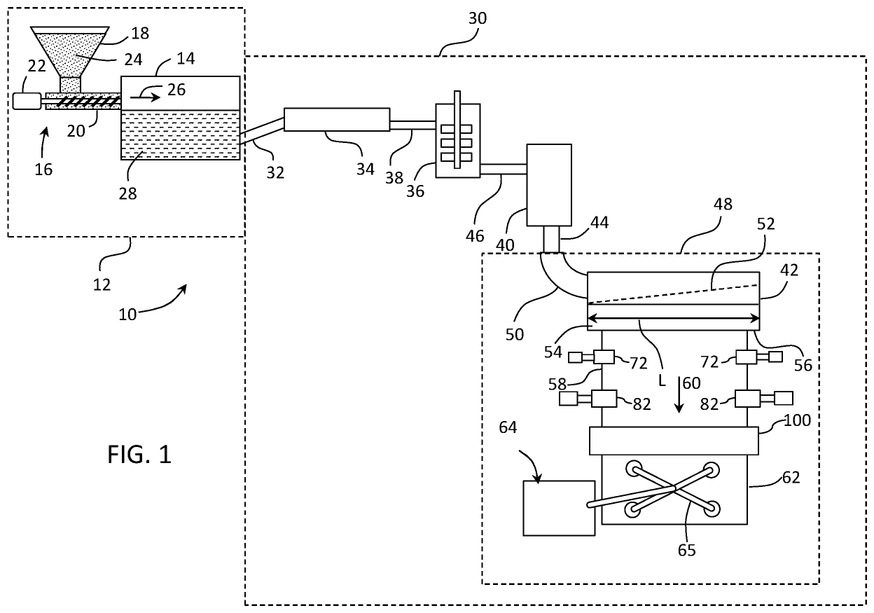

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e., fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

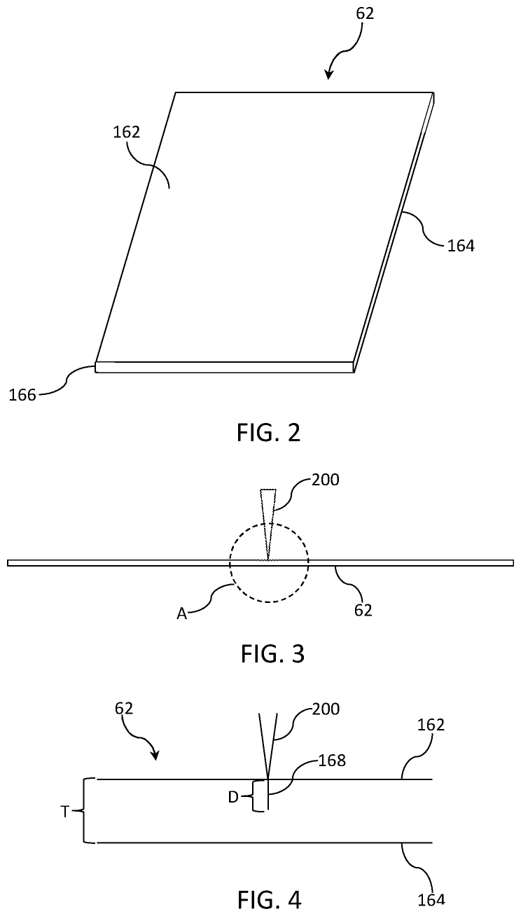

FIG. 2 shows a perspective view of a glass article, specifically a glass sheet 62 having a first major surface 162, a second major surface 164 extending in a generally parallel direction to the first major surface 162 (on the opposite side of the glass sheet 62 as the first major surface) and an edge surface 166 extending between the first major surface 162 and the second major surface 164 and extending in a generally perpendicular direction to the first and second major surfaces 162, 164.

FIG. 3 shows a side schematic view of a glass sheet scoring operation in accordance with embodiments disclosed herein. FIG. 4 shows an exploded side schematic view of area ‘A’ of FIG. 3. Glass sheet scoring operation includes imparting a score line 168 across first major surface 162 of glass sheet 62. Score line 168 is imparted via scoring mechanism 200 which can include, for example, a score wheel or other scoring device as known to persons having ordinary skill in the art.

In certain exemplary embodiments, glass sheet 62 can have a thickness ‘T’ (defined as the closest distance between first major surface 162 and second major surface 164 of glass sheet 62) ranging from about 0.1 millimeter to about 0.5 millimeters, such as from about 0.2 millimeters to about 0.4 millimeters and the score line can have a depth ‘D’ (defined as the average distance the score line extends within the glass sheet 62 in the thickness direction) ranging from about 10 microns to about 50 microns, such as from about 20 microns to about 40 microns.

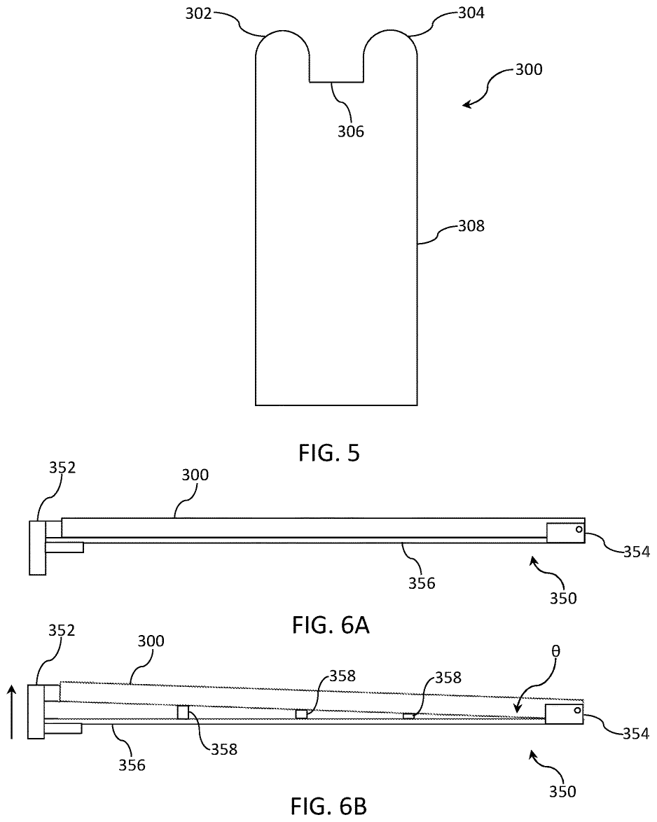

FIG. 5 shows an end cutaway schematic view of a glass sheet separation member, specifically a glass sheet separation bar 300 in accordance with embodiments disclosed herein. Glass sheet separation bar 300 includes a first raised surface 302, a second raised surface 304, an intermediate surface 306 extending between the first raised surface 302 and the second raised surface 304, and a body portion 308 extending below the first raised surface 302, the second raised surface 304, and the intermediate surface 306. As can be seen in FIG. 5, first major surface 302 and second major surface 304 are curved such that each extend along semicircular cross sections that are separated by intermediate surface 306. Glass sheet separation bar 300 extends along a longitudinal length (as shown in FIGS. 6A and 6B) such that each of first raised surface 302, second raised surface 304, and intermediate surface 306 extend along the longitudinal length of glass sheet separation bar 300.

FIGS. 6A and 6B are side schematic views of a glass sheet separation bar 300 and tilting mechanism 350 in accordance with embodiments disclosed herein. Tilting mechanism 350 includes a lifting mechanism 352 on a first end along its longitudinal length and a hinge mechanism 354 on an opposing second end of its longitudinal length. Tilting mechanism 350 also includes support mechanisms 358 extending between glass sheet separation bar 300 and fixed base 356. And while FIG. 6B shows three support mechanisms 358, embodiments disclosed herein may include greater or fewer support mechanisms 358 extending between glass sheet separation bar 300 and fixed base 356.

As shown in FIGS. 6A and 6B, tilting mechanism 350 is configured to raise and lower one end of glass sheet separation bar 300, specifically the end of glass sheet separation bar 300 that is proximate to lifting mechanism 352. In FIG. 6A, the end of glass sheet separation bar 300 that is proximate to lifting mechanism 352 is shown in a lowered state, such that glass sheet separation bar 300 is parallel to fixed base 356. In FIG. 6B, the end of glass sheet separation bar 300 that is proximate to lifting mechanism 354 is shown in a raised state, such that glass sheet separation bar 300 is tilted relative to fixed base 356, wherein a tilt angle of longitudinal axis of glass sheet separation bar 300 relative to longitudinal axis of fixed base 356 is indicated by ‘θ’ in FIG. 6B.

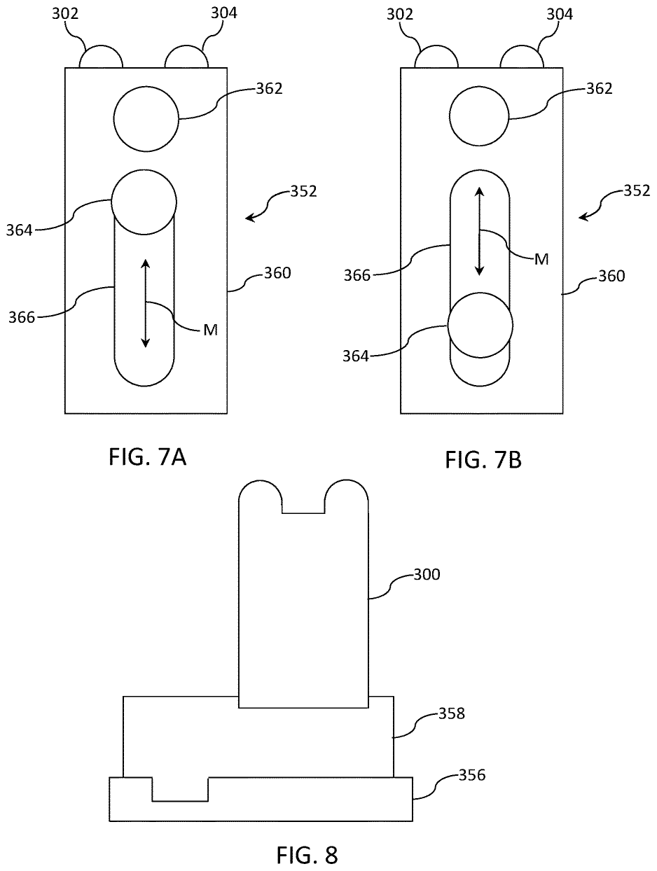

FIGS. 7A and 7B show end schematic views of a lifting mechanism 352 in accordance with embodiments disclosed herein. Specifically, FIG. 7A shows an end schematic view of a lifting mechanism 352 wherein glass separation bar 300 is in a lowered state and FIG. 7B shows an end schematic view of a lifting mechanism 352 wherein glass separation bar 300 is in a raised state. Lifting mechanism 352 includes housing 360, slot 366, separation bar nut 362 (aligned with longitudinal axis of glass sheet separation bar 300) and fixed base nut 364 (aligned with longitudinal axis of fixed base 356).

In the lowered state shown in FIG. 7A, housing 360 and separation bar nut 362 are in a lower position relative to fixed base nut 364 and in the raised state, shown in FIG. 7B, housing 360 and separation bar nut 362 are in a higher position relative to fixed base nut 364, wherein vertical movement of housing 360 relative to fixed base 364 is shown by arrow ‘M.’ In operation, fixed base nut 364 can be loosened when raising or lowering housing 360 and then tightened when housing 360 has been set to the desired elevation. And when housing 360 is raised or lowered, the end of glass sheet separation bar 300 proximate to lifting mechanism 352 is correspondingly raised or lowered while opposite end of glass sheet separation bar 300 pivots around hinge mechanism 354.

In certain exemplary embodiments, tilting mechanism 350 tilts or is configured to tilt the glass sheet separation bar 300 at an angle ‘θ’ of about 0.5 degrees to about 5 degrees, such as from about 1 degree to about 3 degrees relative to horizontal.

FIG. 8 shows an end cutaway schematic view of a glass sheet separation bar 300 and support mechanism 358 in accordance with embodiments disclosed herein. Support mechanism 358 rests on fixed base 356 and glass sheet separation bar 300 rests on support mechanism 358. Support mechanism 358 provides mechanical support to glass sheet separation bar 300 when glass sheet separation bar 300 is tilted relative to fixed base 356.

For example, one or more support mechanisms 358 can be inserted between glass sheet separation bar 300 and fixed base 356 when separation bar 300 has been tilted to a desired degree by tilting mechanism 350.

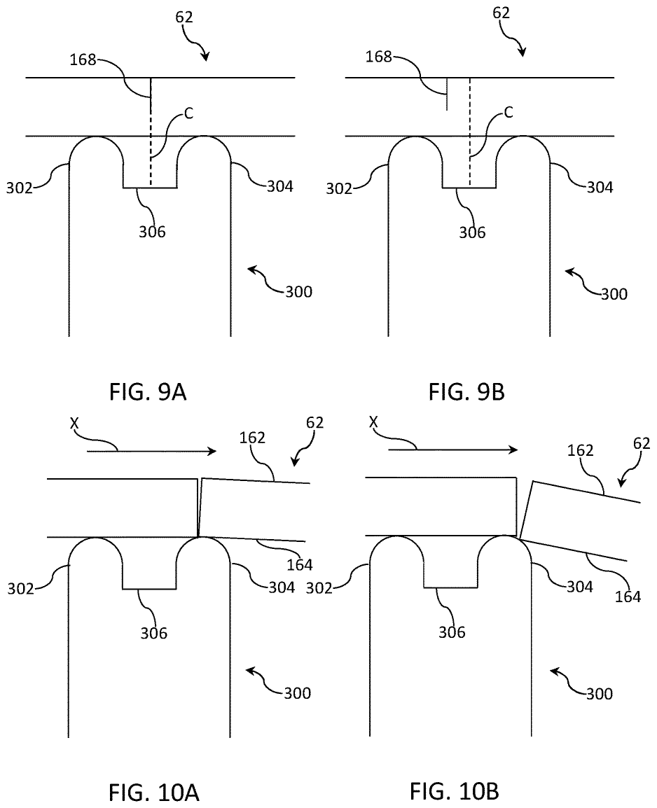

FIGS. 9A and 9B show end cutaway schematic views of a scored glass sheet 62 and glass sheet separation bar 300 in accordance with embodiments disclosed herein. In FIG. 9A, score line 168 is offset (to the left) of centerline ‘C’ of glass sheet separation bar 300 and in FIG. 9B, score line 168 is aligned with glass sheet separation bar 300. As can be seen in FIGS. 9A and 9B, first raised surface 302 and second raised surface 304 contact glass sheet 62 whereas intermediate surface does not contact glass sheet 62.

FIGS. 10A and 10B show end cutaway schematic views of glass sheet 62 separation in accordance with embodiments disclosed herein. As glass sheet 62 is moved relative to glass sheet separation bar 300 (such as shown by arrow ‘X’), separation occurs along score line (not shown in FIGS. 10A and 10B) previously imparted in first major surface 162 (as shown, for example, in FIG. 4). As can be seen in FIG. 10A, glass sheet separation bar 300, specifically, second raised surface 304, contacts second major surface 164 as glass sheet 62 is separated.

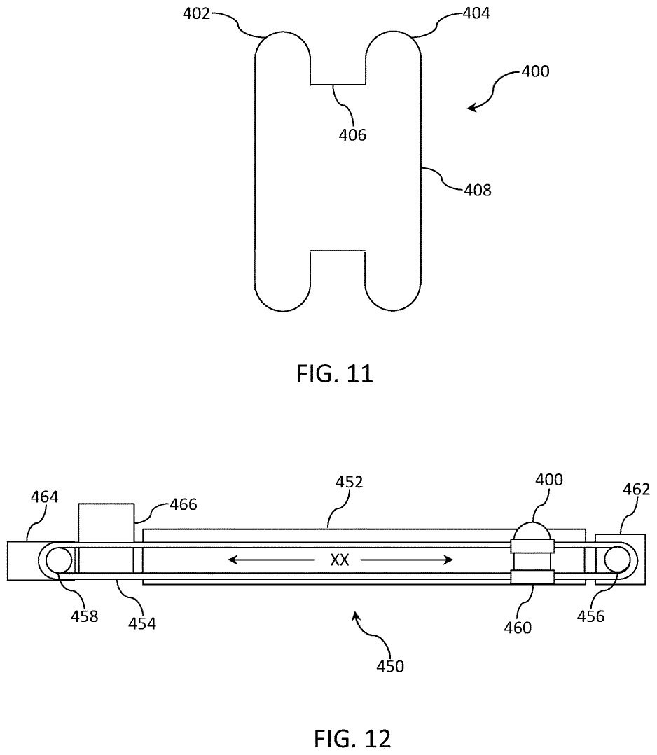

FIG. 11 shows an end cutaway schematic view of a glass sheet separation member, specifically a glass sheet separation wheel 400 in accordance with embodiments disclosed herein. Glass sheet separation wheel 400 includes a first raised surface 402, a second raised surface 404, an intermediate surface 406 extending between the first raised surface 402 and the second raised surface 404, and a body portion 408 extending below the first raised surface 402, the second raised surface 404, and the intermediate surface 406. As can be seen in FIG. 11, first major surface 402 and second major surface 404 are curved such that each extend along semicircular cross sections that are separated by intermediate surface 406.

FIG. 12 shows a perspective schematic view of a glass sheet separation mechanism 450 in accordance with embodiments disclosed herein. Glass sheet separation mechanism 450 includes guide plate 452 and drive conveyor 454, which may, for example, comprise a drive belt or drive chain, configured to move glass sheet separation wheel 400 across a longitudinal length of glass sheet separation mechanism 450 (as indicated by double arrow ‘XX’ in FIG. 12). Glass sheet separation wheel 400 is mounted on mounting frame 460, which is in turn mounted on drive conveyor 454. Driving motor 462 drives rotation of first spindle 456, which, in turn, effectuates movement of drive conveyor 454 and second spindle 458, wherein mounting frame 460 and glass sheet separation wheel 400 move in concert with drive conveyor 454. Glass sheet separation mechanism 450 also includes tensioning mechanism 464, which can effectuate lateral movement (as indicated by double arrow ‘XX’ in FIG. 12) of second spindle 458 in order to adjust the tension of drive conveyor 454. Glass sheet separation mechanism 450 also includes glass sheet separation wheel cleaning mechanism 466.

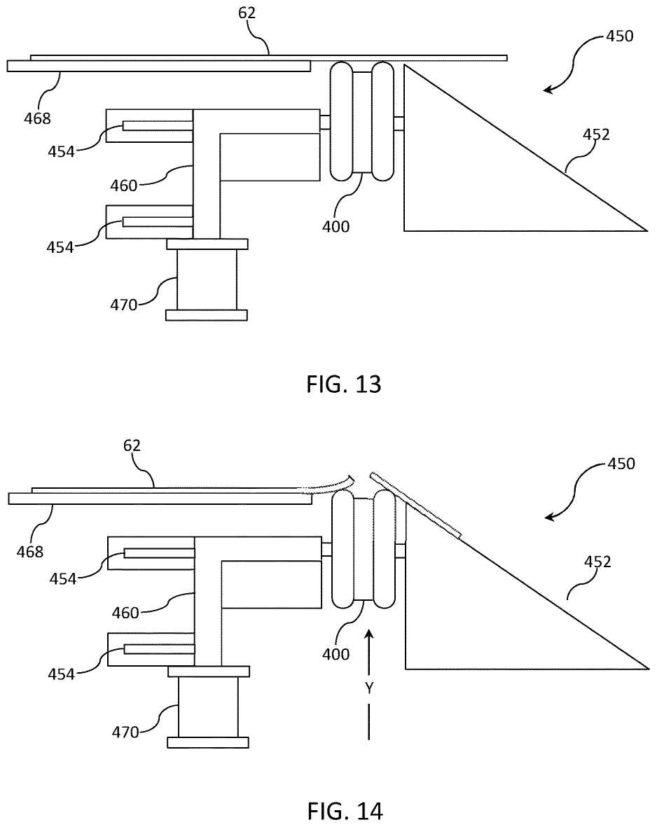

FIG. 13 shows an end cutaway schematic view of the glass sheet separation mechanism 450 of FIG. 12 in a first position. As can be seen in FIG. 13, glass sheet 62 is situated on support plate 468 and top of glass sheet separation wheel 400 is at the same elevation as top of support plate 468 such that no separating force is applied to the glass sheet 62 by the glass sheet separation wheel 400.

FIG. 14 shows an end cutaway schematic view of the glass sheet separation mechanism 450 of FIG. 12 in a second position. As can be seen in FIG. 14, top of glass sheet separation wheel 400 is at a higher elevation than top of support plate 468 such that a separating force is applied to glass sheet 62 causing separation of a portion of glass sheet 62 onto guide plate 452. Specifically, separating force is applied to glass sheet 62 by upward movement of glass sheet separation wheel 400 relative to glass sheet 62 (as indicated by arrow ‘Y’in FIG. 14) by action of driver 470 (e.g., servo motor, etc.) on mounting frame 460.

While in the second position, glass sheet separation wheel 400 can apply a separation force on glass sheet 62 while glass sheet separation wheel 400 moves across a major surface of glass sheet 62. Specifically, while in the second position, glass sheet separation wheel 400 can be moved across a major surface of glass sheet 62 through operation of glass sheet separation mechanism 450 wherein, with reference to FIG. 12, glass sheet separation wheel 400 mounted on mounting frame 460 is moved in concert with drive conveyor 454.

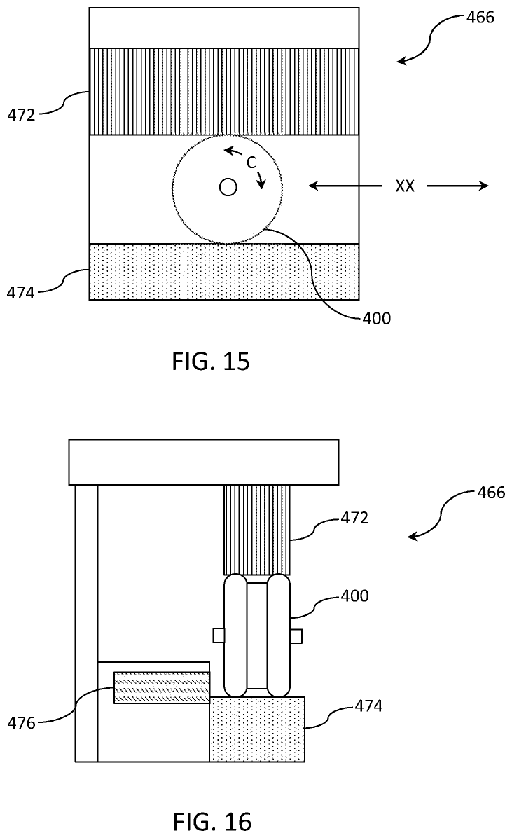

FIGS. 15 and 16 show, respectively, side and end cutaway schematic views of a glass sheet separation wheel cleaning mechanism 466 in accordance with embodiments disclosed herein. Glass sheet separation wheel cleaning mechanism 466 includes cleaning component 472 (e.g., cleaning brush(es)) and friction seat 474 wherein lateral movement of glass sheet separation wheel 400 (as indicated by double arrow ‘XX’ in FIG. 15) across friction seat 474 causes rotation of glass sheet separation wheel 400 (as indicated by curved arrow ‘C’ in FIG. 15) effectuating removal of debris from glass sheet separation wheel 400 by cleaning component 472. Such debris can be, in turn, be removed from glass sheet separation wheel cleaning mechanism 466 suction mechanism 476 (e.g., vacuum pump).

Embodiments disclosed herein can, for example, enable more controlled and efficient separation of glass articles, such as glass sheets, which can in turn enable more efficient production of glass articles, such as glass sheets, with better and more uniform edge quality.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. An apparatus for manufacturing a glass article comprising:
a scoring mechanism configured to impart a score line across a first major surface of the glass article; and
a separating mechanism comprising a glass sheet separation member, the glass sheet separation member comprising a first raised surface, a second raised surface, and an intermediate surface extending between the first raised surface and the second raised surface, each of the first raised surface, the second raised surface, and the intermediate surface extending along a longitudinal length of the glass sheet separation member, wherein the first raised surface and the second raised surface are configured to contact the glass article and the intermediate surface is configured not to contact the glass article.

2. The apparatus of claim 1, wherein the first major surface and the second major surface are curved.

3. The apparatus of claim 1, wherein the glass sheet separation member comprises a glass sheet separation bar and the apparatus further comprises a tilting mechanism configured to raise and lower one end of the glass sheet separation bar.

4. The apparatus of claim 3, wherein the tilting mechanism comprises a lifting mechanism and a hinge mechanism.

5. The apparatus of claim 3, wherein the tilting mechanism comprises at least one support mechanism.

6. The apparatus of claim 3, wherein the tilting mechanism is configured to tilt the glass sheet separation bar at an angle of about 0.5 degrees to about 5 degrees relative to horizontal.

7. The apparatus of claim 1, wherein the glass sheet separation member comprises a glass sheet separation wheel and the apparatus further comprises a glass sheet separation mechanism configured to move the glass sheet separation wheel relative to the glass article.

8. The apparatus of claim 7, wherein the glass sheet separation mechanism is configured to cause the glass sheet separation wheel to apply a separation force on the glass article while the glass sheet separation wheel moves across a major surface of the glass article.

9. The apparatus of claim 7, wherein the glass sheet separation mechanism further comprises a glass sheet separation wheel cleaning mechanism configured to remove debris from the glass sheet separation wheel.

10. A method for manufacturing a glass article comprising:
imparting a score line across a first major surface of the glass article with a scoring mechanism; and
applying a separating force to the glass article, the separating force being applied by a glass sheet separation member, the glass sheet separation member comprising a first raised surface, a second raised surface, and an intermediate surface extending between the first raised surface and the second raised surface, each of the first raised surface, the second raised surface, and the intermediate surface extending along a longitudinal length of the glass sheet separation member, wherein the first raised surface and the second raised surface contact the glass article and the intermediate surface does not contact the glass article.

11. The method of claim 10, wherein the first major surface and the second major surface are curved.

12. The method of claim 10, wherein the glass sheet separation member comprises a glass sheet separation bar and the method further comprises operating a tilting mechanism to raise or lower one end of the glass sheet separation bar.

13. The method of claim 12, wherein the tilting mechanism comprises a lifting mechanism and a hinge mechanism.

14. The method of claim 12, wherein the tilting mechanism comprises at least one support mechanism.

15. The method of claim 12, wherein the tilting mechanism tilts the glass sheet separation bar at an angle of about 0.5 degrees to about 5 degrees relative to horizontal.

16. The method of claim 10, wherein the glass article comprises a glass sheet having a thickness ranging from about 0.1 millimeter to about 0.5 millimeters and the score line has a depth ranging from about 10 microns to about 50 microns.

17. The method of claim 10, wherein the glass sheet separation member comprises a glass sheet separation wheel and the method further comprises operating a glass sheet separation mechanism to move the glass sheet separation wheel relative to the glass article.

18. The method of claim 17, wherein the glass sheet separation mechanism moves the glass sheet separation wheel across a major surface of the glass article.

19. The method of claim 17, wherein the method further comprises removing debris from the glass sheet separation wheel by operating a glass sheet separation wheel cleaning mechanism.

20. A glass article made by the method of claim 10.

21. An electronic device comprising the glass article of claim 20.
